(19) United States
(12) Patent Application Publication
(10) Pub. No.: US 2012/0066350 A1
(43) Pub. Date: Mar. 15, 2012

(54) PROGRAM RECOMMENDATION METHOD, TERMINAL DEVICE, AND NETWORK SYSTEM

(75) Inventors: Teng SHI, Shenzhen (CN); Yuanyuan ZHANG, Shenzhen (CN); Yonghui TIAN, Shenzhen (CN); Peiyu YUE, Shenzhen (CN); Guangyuan LIU, Shenzhen (CN); Chuxiong ZHANG, Shenzhen (CN); Weizhong YUAN, Shenzhen (CN)

(73) Assignee: HUAWEI TECHNOLOGIES CO., LTD., Shenzhen (CN)

(21) Appl. No.: 13/209,354

(22) Filed: Aug. 12, 2011

Related U.S. Application Data
(63) Continuation of application No. PCT/CN2010/071786, filed on Apr. 15, 2010.

(30) Foreign Application Priority Data
Apr. 15, 2009 (CN) 200910134942.8

(51) Int. Cl. G06F 15/16

(52) U.S. Cl. 709/219

(57) ABSTRACT

Example embodiments provide a program recommendation mechanism that allows a user to recommend select portions of a media stream. For instance, one embodiment allows a terminal of a recommendation receiver to receive a recommendation message sent by a terminal of a recommendation originator, wherein the recommendation message includes a program identity (ID), an ID of a part of program stream recommended by the recommendation originator, or both. Further, an instruction message for instructing a media function (MF) server to deliver the part of program stream of the program is sent according to the program ID, the ID of the part of program stream, or both. Thereafter, the part of program stream delivered by the MF is received and played.

### CROSS-REFERENCE TO RELATED APPLICATIONS

This application is a continuation of International Application No. PCT/CN2010/071786, filed on Apr. 15, 2010, which claims priority to Chinese Patent Application No. CN 200910134942.8, filed on Apr. 15, 2009, both of which are hereby incorporated by reference in their entireties.

### FIELD OF THE TECHNOLOGY

The present invention relates to the field of communication technology, and more particularly to methods, systems and devices for program recommendation.

### BACKGROUND OF THE INVENTION

Nowadays, an Internet protocol television (IPTV) service and a communication service are merged to generate some value-added services, for example, the Amigo TV™. The Amigo TV is a value-added service in which a user who is watching an IPTV program can invite other users to watch the TV program together through the network. The Amigo TV is not only applicable in the IPTV but also applicable in TV services of personal computers (PCs) and mobile terminals.

When a user (a recommendation originator) recommends a program to a friend (a recommendation receiver), a terminal of the user (the recommendation originator) sends a recommendation message to a terminal of the friend (the recommendation receiver). The recommendation message includes an identity (ID) of the program. The terminal of the friend sends a playing request to a media function (MF) server according to the ID of the program. The MF server delivers the program stream to the terminal of the friend.

Although the aforementioned recommendation mechanism allows for one's friends to consume a user's recommendations, such mechanism has several disadvantages. For example, when the terminal of the friend receives the program stream delivered by the MF, the program stream can only be played to the friend from beginning to end. Accordingly, the friend can only watch the recommended program from beginning to end, causing a bad user experience.

### SUMMARY OF THE INVENTION

Embodiments of the present invention provide program recommendation methods, devices, systems and computer program products that realize recommendation of important or desired parts of program streams.

For example, one example embodiment provides a program recommendation method for realizing recommendation of important parts of program streams. In this embodiment, a terminal of a recommendation receiver receives a recommendation message sent by a terminal of a recommendation originator. The recommendation message includes a program ID and an ID of a part of program stream recommended by the recommendation originator. Next, an instruction message for instructing a media function (MF) server to deliver the part of program stream of the program is sent according to the program ID and the ID of the part of program stream. Thereafter, the part of program stream delivered by the MF server is received.

Another embodiment provides a program recommendation method, wherein a terminal of a recommendation receiver receives a recommendation message sent by a terminal of a recommendation originator. The recommendation message typically includes a program ID and range information of a part of image recommended by the recommendation originator. Thereafter, display mode information of the part of image can obtained and an instruction message for instructing an MF server to deliver a program stream can then be sent according to the program ID. Note that in this embodiment, the program stream delivered by the MF server is received and the program stream is played according to the range information of the part of image and the display mode information of the part of image.

In yet another example embodiment, the present invention provides a terminal device that includes a message receiving unit, a message sending unit, and a program-stream receiving unit. The message receiving unit is configured to receive a recommendation message, which includes a program ID and an ID of a part of program stream recommended by a recommendation originator. Similarly, the message sending unit is configured to send an instruction message for instructing an MF server to deliver a part of program stream of the program according to the program ID and the ID of the part of program stream. Related thereto, the program-stream receiving unit is configured to receive the part of program stream delivered by the MF server.

Still other example embodiments provide for a terminal device, which includes a message receiving unit, an obtaining unit, a message sending unit, a program-stream receiving unit, and a playing unit. In this embodiment, the message receiving unit is configured to receive a recommendation message that includes a program ID and range information of a part of image recommended by a recommendation originator. After receiving the recommendation message, the obtaining unit is configured to obtain display mode information of the part of image. Similarly, the message sending unit is configured to send an instruction message for instructing an MF server to deliver a program stream according to the program ID. The program-stream receiving unit is configured to receive the program stream delivered by the MF server, while the playing unit is configured to play the program stream according to the range information of the part of image and the display mode information of the part of image.

Other example embodiments provide a network system includes a terminal of a recommendation originator and a terminal of a recommendation receiver. In this embodiment, the terminal of the recommendation originator is configured to receive a recommendation condition including recommendation instruction information of a part of program stream, and send a recommendation message to the terminal of the recommendation receiver according to the recommendation condition. Note that the recommendation message includes a program ID and an ID of the part of program stream recommended by the recommendation originator.

In the above embodiment, the terminal of the recommendation receiver is configured to receive the recommendation message sent by the terminal of the recommendation originator and send an instruction message for instructing an MF server to deliver the a part of program stream of the program according to the program ID and the ID of the part of program stream, and receive the part of program stream delivered by the MF server.

In a related example embodiment, the terminal of the recommendation originator is configured to receive a recommendation condition including range instruction information of a part of image, and send a recommendation message to the terminal of the recommendation receiver according to the recommendation condition. The recommendation message includes a program ID and range information of the part of image recommended by the recommendation originator. Likewise, the terminal of the recommendation receiver is configured to receive the recommendation message sent by the recommendation originator of the terminal, obtain display mode information of the part of image, send an instruction message for instructing an MF server to deliver the program stream according to the program ID, receive the program stream delivered by the MF server, and play the program stream according to the range information of the part of image and the display mode information the part of image.

In yet another example embodiment of the present invention, the terminal of the recommendation receiver can instruct the MF server to deliver a part of program stream only according to the ID of the received part of program stream, so as to achieve an objective of recommendation of a part of program stream, and at the same time, as the MF server only needs to deliver a part of program stream, resources such as network bandwidth can be saved.

Another embodiment of the present invention provides that the terminal of the recommendation receiver cam play the program stream received from the MF server according to the range information of the part of image and the display mode information of the part of image, so as to achieve an objective of recommendation of important images in the program stream.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantageous features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a flow chart of a program recommendation method according to an example embodiment of the present invention;

FIG. 2 illustrates a flow chart of a program recommendation method according to another example embodiment of the present invention;

FIG. 3 illustrates a flow chart of a program recommendation method according to other example embodiments of the present invention;

FIG. 4 illustrates a flow chart of a program recommendation method according to other related embodiments of the present invention;

FIG. 5 illustrates a flow chart of a program recommendation method according to still other example embodiment of the present invention;

FIG. 6 provides an example structural view of a terminal device configured to implement various example embodiment of the present invention;

FIG. 7 provides an example structural view of a terminal device configured to implement the program recommendation embodiments of the present invention; and

FIG. 8 provides a structural view of a network system configured to implement program recommendation embodiments of the present invention.

### DETAILED DESCRIPTION OF THE EMBODIMENTS

The present invention extends to methods, systems, apparatuses and computer program products for recommending selected portions of programs, without requiring a view to play an entire program. The embodiments of the present invention may comprise a special purpose or general-purpose computer including various computer hardware components or modules, as discussed in greater detail below.

Although more specific reference to advantageous features are described in greater detail below with regards to the Figures, embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described above are example forms of implementing the claims.

As used herein, the term “module” or “component” can refer to software objects or routines that execute on a general or specific computing system. The different components, modules, engines, and services described herein may be implemented as objects or processes that execute on the computing system (e.g., as separate threads). While the system and methods described herein can be implemented in software, implementations in hardware (or a combination of software and hardware) are also possible and contemplated. In this description, a “computing entity” may be any computing system as previously defined herein, or any module or combination of modules running on a computing system (e.g., a handheld terminal device).

As previously mentioned, the present invention provides for methods, systems, apparatuses and computer program products for providing recommended program listings to one's friends, family or other desired persons. The following provides a general description of various scenarios and example embodiments or configuration of systems and apparatuses for use in implement various described embodiments. Although reference may be made to a specific embodiment, one will recognize that varying combinations of the all embodiments described herein are possible. Accordingly, each described embodiment should be broadly interpreted to include one or more aspects from other described embodiments and any specific reference to a particular embodiment is used herein for illustrative purposes only and is not meant to limit or otherwise narrow the scope of the present invention.

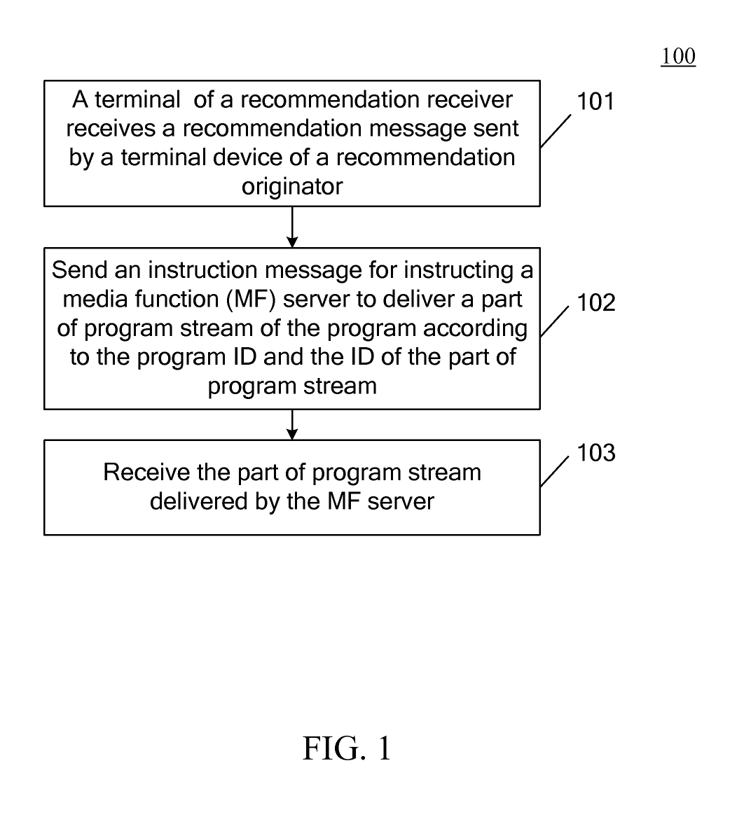

The present invention may also be described in terms of methods comprising functional steps and/or non-functional acts. The following provides a description of steps and/or acts that may be performed in practicing the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use of steps and/or acts in the recitation of the claims—and in the following description of the flowcharts or diagram(s) for FIGS. 1-5 are used to indicate the desired specific use of such terms.

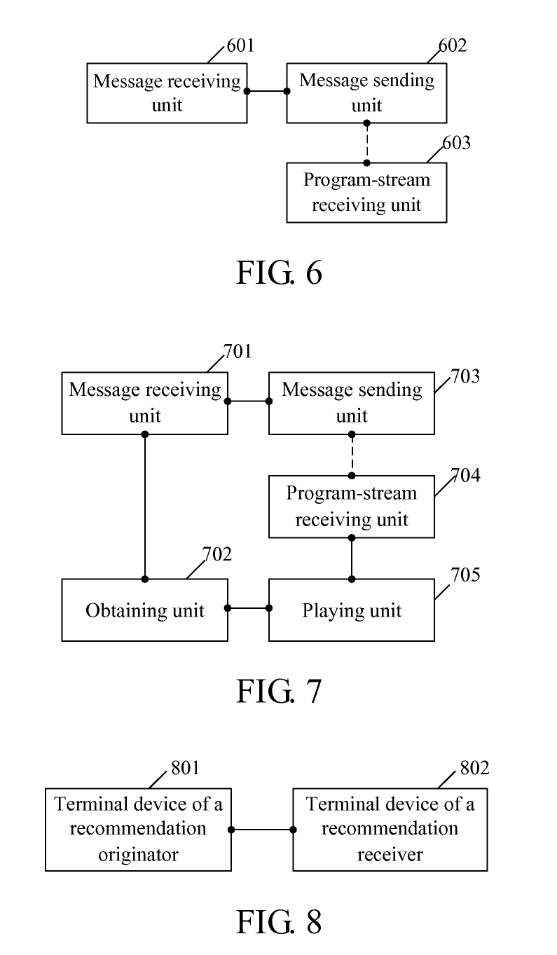

As previously mentioned, FIGS. 1-5 illustrates flowcharts or diagrams for various exemplary embodiments of the present invention. The following description of FIGS. 1-5_will occasionally refer to corresponding elements from the described apparatus and systems described in greater detailed below with reference to FIGS. 6-8. Although reference may be made to a specific element from the description and Figures, such references are used for illustrative purposes only and are not meant to limit or otherwise narrow the scope of the described embodiments unless otherwise explicitly claimed.

### Program Recommendation

Referring now to the Figures, FIG. 1 illustrates a flow diagram of a program recommendation method 100 according to an example embodiment of the present invention. As shown, includes the method 100 includes a step 101, wherein a terminal of a recommendation receiver receives a recommendation message sent by a terminal of a recommendation originator. Note that the recommendation message generally includes a program ID and possibly an ID of a part of program stream recommended by the recommendation originator.

In step 102 of method 100, an instruction message for instructing a media function (MF) server to deliver the part of program stream of the program is sent according to the program ID and the ID of the part of program stream. The method 100 then includes a step 103, wherein the part of program stream delivered by the MF is received.

As described in greater detail below, the instruction message may include a session negotiation request message. In such embodiment, the session negotiation request message includes transmission channel information of the part of program stream. Further still, other embodiments allow the program ID may be used as address information of the program.

Note that embodiments described herein allow resources savings (e.g., network bandwidth). In other words, the MF server only needs to deliver the part of program stream; and therefore, resource such as the network bandwidth may be saved. In other words, because embodiments described herein provide that the terminal of the recommendation receiver instructs the MF server to deliver a part of program stream (instead of the entire program) according to the received ID of the part of program stream, embodiments realize recommendation of the part of program stream, and at the same time, limit network bandwidth and enhance user experience by not requiring the entire playback of the program.

### Program Recommendation Interface

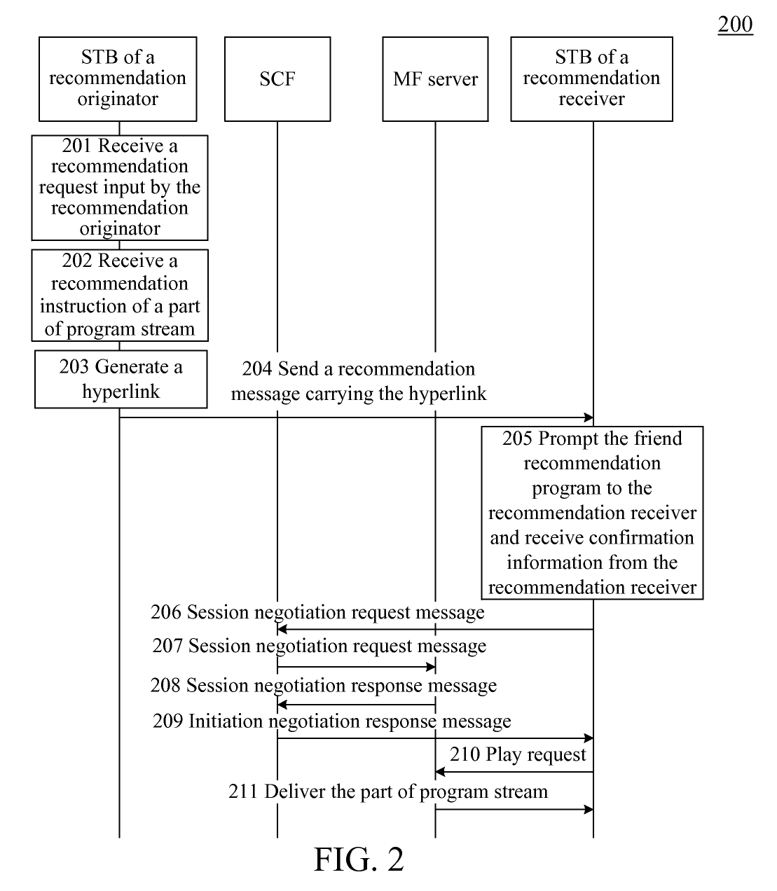

Referring now to FIG. 2, FIG. 2 illustrates a flow chart or diagram of a program recommendation method 200 that provides a program interface according to another embodiment of the present invention. As show, method 200 includes a step 201, wherein a set top box (STB), or other similar device, of a recommendation originator receives a recommendation request inputted by the recommendation originator, and provides a recommendation operation interface for the recommendation originator.

Note that the above embodied step may be applicable in various scenarios. For example, The recommendation originator may find that an original sound track of a movie is very good to use as listening materials and intends to recommend the sound track to a friend (a recommendation receiver). In such instance, the recommendation originator can select, e.g., a “recommend” button in a menu by using a remote or other selection device or module. At this time, the STB of the recommendation originator receives the recommendation request of the recommendation originator and can display a recommendation operation interface.

Note that although the above mechanism for displaying a recommendation operation interface required a user to select a “recommend” button, other well know mechanisms are also contemplated herein. For example, the interface may be displayed in response to a verbal or other type of command input. As such, any specific mechanism for displaying the recommendation operation interface is used herein for illustrative purposes only and is not meant to limit or otherwise narrow the scope of the present invention unless otherwise explicitly claimed.

Regardless of how the recommendation operation interface is displayed, method 200 also includes step 202, wherein the STB receives a recommendation condition inputted at the operation interface by the recommendation originator, and receives information of the recommendation receiver. In this embodiment, the recommendation condition may include recommendation instruction information of a part of program stream.

Continuing with the foregoing example or scenario, the recommendation originator may select a “recommend audio only” item in, e.g., a drop-down menu in the recommendation operation interface. Further, the recommendation originator may also select a recommendation target or object (that is, the recommendation receiver) in, e.g., a friend list. Of course, other well known mechanism for selecting or setting recommendation conditions is contemplated herein. As such, any specific use of items, menus, lists, targets, objects or other verbal or visual input mechanism described herein is used for illustrative purposes only and is not meant to limit or narrow the scope of the present invention unless otherwise specifically claimed. Notwithstanding any specific mechanism used to select and send the “recommend audio only” condition to the recommendation receiver, at this time, the STB may receive the recommendation condition of the “recommend audio only” and may also receive information of the recommendation receiver.

Of course, other embodiments consider other user interfaces for selecting or setting recommendation conditions other than the automated user interface components. For example, one example embodiment provides that the recommendation originator may also input the recommendation condition in the recommendation operation interface manually. For example, a script or command line type interface may also be used to select and/or send recommendation conditions to the recommendation receiver. Of course, other manual mechanisms, such as the use of input/output (I/O) hardware and logical components or module, may also be used to implement embodiments described herein. Accordingly, any specific type of interface or I/O mechanism used in selecting or setting recommendation conditions is used herein for illustrative purposes only, and is not meant to limit or narrow the scope of the present invention unless otherwise explicitly claimed.

Method 200 also includes step 203, wherein the STB of the recommendation originator generates recommendation instructions for sending to the recommendation receiver, wherein the recommendation instructions may be generated according to the recommendation instruction information of the part of program stream and/or the ID of the current program. In one embodiment, the recommendation instructions includes a hyperlink, similar to the following:

IPTV://CoDServer/movie1/ep22?streamID=audio1.

In such embodiment, various parts of the hyperlink may represent various instructions related to the recommendation conditions selected or set. For example, one part of the hyperlink (e.g., the IPTV://CoDServer/movie1/ep22) may indicate a demand address of the program, while another part of the hyperlink (e.g., the audio1) may represent an ID of the audio stream, Similarly, some other part of the command or hyperlink (e.g., the ?streamID=audio1) may identify that only the audio stream is recommended. Of course, other mechanisms and commands for generating recommendation instructions are also contemplated herein. As such, the above use of a hyperlink for generating recommendation instructions is used herein for illustrative purposes only and is not meant to limit or narrow the scope of the present invention unless otherwise explicitly claimed.

Method 200 also includes step 204, wherein the STB of the recommendation originator sends a recommendation message carrying the recommendation instructions (e.g., a hyperlink) to an STB of the recommendation receiver. In one embodiment, the recommendation message can be a session initiation protocol (SIP) message formatted similar to the following:

MESSAGE sip:xiaoxue@domain.com SIP/2.0
Via: SIP/2.0/TCP Potianpc.domain.com;branch=z9hG4bK776sgdkse
Max-Forwards: 70
From: sip:Potian@domain.com;tag=49583
To: sip:xiaoxue@domain.com
Call-ID: asd88asd77a@1.2.3.4
CSeq: 1 MESSAGE
Content-Type: text/plain ; application-type= content sharing
Content-Length: 50
IPTV://CoDServer/movie1/ep22? streamID=audio1.

Of course, the recommendation message in step 204 can also be other messages instead of the SIP message. For example, the recommendation message may be a short messaging service (SMS), or any other type of message used to send commands or instructions. As such, any use of any specific type of message for sending recommendation instructions to the recommendation.

In step 205 of method 200, after receiving the recommendation message, the STB of the recommendation receiver relays or otherwise communicates the recommendation message to user or the recommendation receiver; thus prompting the recommendation receiver to take action. For example, the STB display a message such as: “Your friend Mark recommends the following segment or part of a media stream” (for example, an audio stream). The STB may further prompt the user or recommended receiver by displaying or otherwise communicating a request for input such as: “Do you wish to receive the program segment? Yes or No.” Thereafter, the STB receives confirmation information or input regarding the recommendation from the recommendation receiver.

Of course, similar to selection of recommendation conditions, many types of well known I/O mechanisms are contemplated herein for communicating the recommendation and prompting the recommendation receiver for input. As such, any specific mechanism described herein for implementation of this embodiment is used herein for illustrative purposes only and is not meant to limit or narrow the scope of the present invention unless specifically claimed.

Assuming the recommendation receiver wishes to receive the selected portion of media stream recommended, in step 206 of method 200, the STB of the recommendation receiver initiates a session negotiation request message, which may include, e.g., transmission channel information (e.g., an audio stream in the current example) to a service control function (SCF) according to the recommendation message.

Method 200 further includes step 207, wherein the SCF sends the session negotiation request message to the MF server. In method 200, after receiving the session negotiation request message, the MF server in step 208 sends a session negotiation response message to the SCF. Similarly, in step 209 of method 200, the SCF sends the session negotiation response message to the STB of the recommendation receiver. Thereafter, in step 210, the STB of the recommendation receiver sends a playing request to the MF. Then, in step 211 of method 200, the MF server delivers the part of program stream to the STB of the recommendation receiver, and the STB of the recommendation receiver plays the part of program stream.

In another example embodiment, the recommendation originator can also specify a certain time period of the part of program stream. At this time, in step 202, the STB of the recommendation originator receives time period instruction information input by the recommendation originator. Correspondingly, the recommendation instructions (e.g., a hyperlink) generated in step 203 may include the time period instruction information; and therefore, in step 211 the MF server delivers a part of media stream within the time period (for example, the audio stream within the time period).

Of course, other types of conditions or restrictions besides time periods are also contemplated herein. For example, the limitations may specify particular frames or clips of a media stream or limit the quality of the recommendation media stream. Furthermore, the condition may be set by someone other than the recommendation originator. For example, the condition may be based on some predefined user preferences or other input from another entity. As such, any specific type of condition or restriction, as well as the entity that requests the limitation, is used herein for illustrative purposes only and is not meant to limit or narrow the scope of the present invention unless otherwise explicitly claimed.

According to yet another example embodiment of the present invention, the STB of the recommendation originator can send an ID that uniquely identifies the part of program to be streamed to the STB of the recommendation receiver. Accordingly, the STB of the recommendation receiver usually only needs to negotiate receiving the part of program stream with the MF server, thereby readily identifying and delivering the recommend the part of program stream. Similarly, because the MF only needs to deliver a part of program stream, resource such as network bandwidth can be saved.

Using Range and/or Display Mode Information for Playback

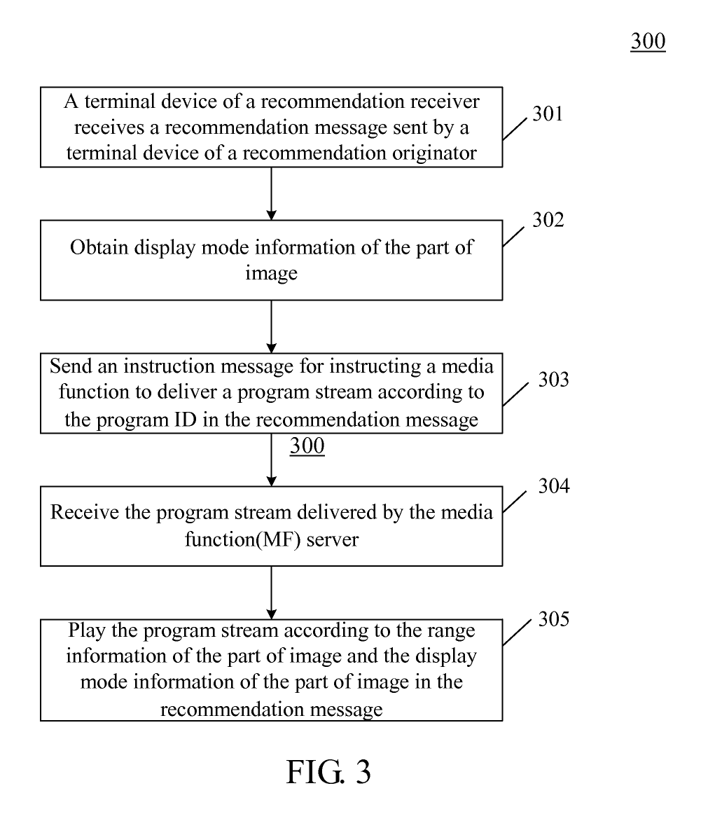

Referring again to the figures, FIG. 3 shows a program recommendation method 300 according to another example embodiment of the present invention, which uses range and display mode information for playback of a media stream. For example, method 300 may include step 301, wherein a terminal of a recommendation receiver receives a recommendation message sent by a terminal of a recommendation originator. In this embodiment, the recommendation message may include a program ID and/or range information of a part of image recommended by the recommendation originator. Note that the program ID may be address information, a pointer, or other mechanism that uniquely identifies the program or at least the appropriate recommended media stream.

Method 300 also includes step 302, which obtains displays mode information of the part of the image. Then in step 303, an instruction message for instructing an MF server to deliver a program stream is sent, e.g., according to the program ID. Then, in step 304, the program stream, delivered by the MF server, is received and in step 305, the program stream is played according to the range information of the part of image and the display mode information of the part of image.

In accordance with one example embodiment, the instruction message may include a session negotiation request message. In a related embodiment, the session negotiation request message may further include transmission channel information of the program stream. Of course, other types of network session information or messages can also be used and utilized by various embodiments described herein. Accordingly, the use of any specific type of session message or other information for session negotiation and establishment is used herein for illustrative purposes only and is not meant to limit or narrow the scope of the present invention unless otherwise explicitly claimed.

Method 300 also includes step 304, which plays the program stream received from the MF server according to the range information of the part of image and the display mode information of the part of image, so as to achieve an objective of recommendation of important images in the program stream.

### Interface for Selecting or Setting Recommendation Input

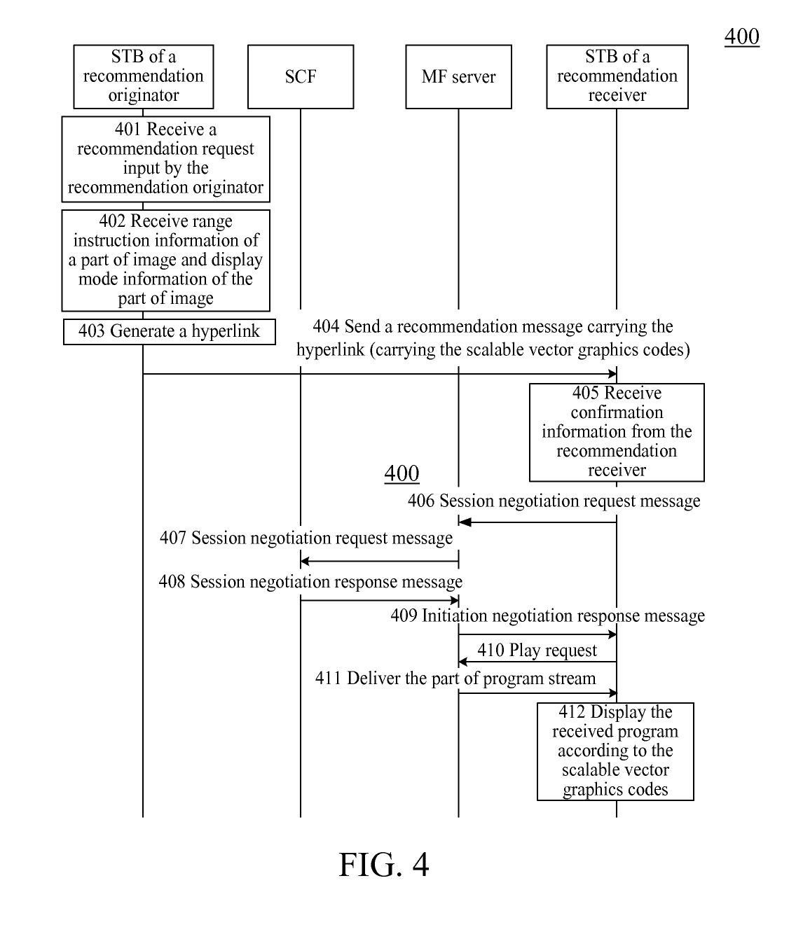

Referring again to the figures, FIG. 4 shows a program recommendation a method 400 according to another example embodiment of the present invention, which provides a user interface for selecting or setting recommendation information. Such embodiment or method 400 may include a step 401, wherein an STB of a recommendation originator receives a recommendation request input by a recommendation originator and provides a recommendation operation interface for the recommendation originator. Note that the operation interface may be provided to the recommendation originator automatically in response to the receiving the recommendation request input or through some other manual process.

Aspects of some of the above embodiment may be best described and understood using the following scenario. Note, that although the following scenario may give specific reference to actions used to access the user interface (UI) or types of object, items, menus, and other user interface (UI) components for the selection process, such actions and objects are used for illustrative purposes and is not meant to limit or narrow the scope of the present invention unless otherwise specifically claimed.

In this example, a recommendation originator may be watching a movie through, e.g., an Internet protocol television (IPTV), whereupon the recommendation originator saw a goof suddenly. For instance, say two characters in the movie are quarrelling at the tenth minute, when a stool is placed at an upper left corner in a long shot. Then suddenly, while the two characters are still quarrelling at the twelfth minute, a bicycle replaces the stool in the upper left corner. At this moment, the recommendation originator wishes to recommend the program clip highlighting the goof to a friend (a recommendation receiver).

Accordingly, similar other mechanisms described herein for UI display, the recommendation originator may initiate the interface using an I/O device. For example, the recommendation originator may selects a “recommend” button in a menu with a remote controller. At this time, the STB of the recommendation originator may receive a recommendation request of the recommendation originator and displays a recommendation operation interface.

Upon displaying the operation interface, Method 400 also includes a step 402, wherein the STB of the recommendation originator receives a recommendation condition inputted by the recommendation originator at the operation interface and receives information of the recommendation receiver. In this embodiment, the recommendation conditions may include one or more of: recommendation instruction information of the part of image; range instruction information of the part of image; time range instruction information; and display mode instruction information of the part of image. Of course, other types of conditions used for indentifying the items the recommendation originator deems important are also contemplated herein, and the use of any specific type of condition or combination of conditions is used herein for illustrative purposes and is not intended to limit or narrow the scope of the present invention unless otherwise explicitly claimed.

Continuing with the foregoing example, the STB of the recommendation originator can receive the recommendation conditions inputted by the recommendation originator at the operation interface. For example, in the recommendation originator may receive a drop-down menu in the recommendation operation interface for selecting a mode of operation from among a plurality of action items. For instance, the recommendation originator may select a “recommend a part of image only” item in the drop-down menu, whereupon s/he selects a range of the part of image in a sub-menu in the recommendation operation interface. Of course, embodiments herein contemplate many types of UIs for the operation interface and for selecting the recommendation selection, the range of the part of the image, and other items described herein. As such, any particular type of UI described herein for the above and below embodiments is used herein for illustrative purposes only and is not meant to limit or narrow the scope for the present invention unless otherwise explicitly claimed.

For example, in one embodiment, a sub-menu in the recommendation operation interface may provide options of “lower-left ⅓ of screen, lower-right ⅓ of screen, upper-left ⅓ of screen, and upper-right ⅓ of screen”. The recommendation originator may then select one or more (for example, lower-left ⅓ of screen) from the several options, wherein the user may also select a display mode of the part of image in the sub-menu in the recommendation operation interface.

For example, another embodiment may provide a sub-menu in the recommendation operation interface, which allows a user to select various options, such as, “highlight display” and/or “highlight ring display”. The recommendation originator may then select one or more display mode (for example, highlight display). For example, in keeping with the above, the recommendation originator may input a time range (e.g., “10 minutes to 12 minutes”) in the sub-menu in the operation interface and selects a recommendation object (e.g., a recommendation receiver) in, e.g., a friend list.

At this time, the STB of the recommendation originator may receive the recommendation instruction information of the part of image, the range instruction information of the part of image (the range of the part of image is lower-left ⅓ of screen), the time period instruction information (the time period is 10 minutes to 12 minutes), and the display mode instruction information of the part of image (the part of image is displayed in a highlight mode) input by the recommendation originator at the operation interface. Of course, other types of instruction information for identifying a recommendation is also contemplated herein and any specific type of instruction information used herein is for illustrative purposes only and is not meant to limit or narrow the scope of the present invention unless otherwise explicitly claimed.

Still other embodiments consider that a sub-menu or other UI may provide various display mode options of the part of image. For example, a display mode option may allow for slow play and fast play of the recommended media stream; albeit, other types of display mode options of the part of the image are also contemplated herein. As such, the specific use of a display mode option is used herein for illustrative purposes only.

Notwithstanding the type of display mode options presented, in keeping with the above the recommendation originator may select the option of slow play, so that the terminal of the recommendation receiver plays the program stream within the time range at a low speed, which may also enhance the recommendation receiver's observation of the foregoing goof.

Method 400 also includes step 403, wherein the STB of the recommendation originator acts to generate scalable vector graphics (SVG) codes according to, e.g., the display mode instruction information of the part of image and the range instruction information of the part of image in the recommendation conditions. Thereafter, step 403 includes an act that generates a recommendation identifier or pointer, e.g., a hyperlink, according to, e.g., the time period instruction information and the SVG codes. For example, if the recommendation identifier is a hyperlink, it may take the following form.

IPTV://CoDServer/movie1/ep22?begin=“10:00”&end=“11:00”&SVG=“ . . . ”,

wherein: (i) the part IPTV://CoDServer/movie1/ep22 is a demand address of the program; (ii) the begin=“10:00”&end=“12:00” identifies that the portion from the tenth minute to the twelfth minute is recommended; and (iii) the SVG=“ . . . ” means the range of the part of image of the program and the display mode information of the part of image. Of course, as previously noted, other types of instruction mechanisms are also contemplated herein and any specific type of identifier and commands used therein is for illustrative purposes only unless otherwise explicitly claimed.

Method 400 also includes step 404, wherein the STB of the recommendation originator sends the recommendation message carrying the recommendation identifier (e.g., a hyperlink) to the STB of the recommendation receiver. Note that similar to other embodiments described above, the recommendation message may be an SIP message or any other well know network messaging type. In any event, one embodiment considers the format of the SIP message similar to the following.

MESSAGE sip:xiaoxue@domain.com SIP/2.0
Via: SIP/2.0/TCP Potianpc.domain.com;branch=z9hG4bK776sgdkse
Max-Forwards: 70
From: sip:Potian@domain.com;tag=49583
To: sip:xiaoxue@domain.com
Call-ID: asd88asd77a@1.2.3.4
CSeq: 1 MESSAGE
Content-Type: text/plain ; application-type= content sharing
Content-Length: 50
IPTV://CoDServer/movie1/ep22? begin=“10:00”&end=“12:00”
& SVG=“...”.

Referring back to FIG. 4, method 400 also includes step 405, wherein after receiving the recommendation message, the STB of the recommendation receiver may prompt the recommendation receiver for action based on the recommendation message. For example, similar to above, the recommendation receiver may be prompted that “Your friend Mark recommends a program to you. Receive it or not?”, whereupon the SVG=“ . . . ” portion in the message may also be saved. In the described example, the STB of the recommendation receiver may then receive a confirmation operation in response to the prompt displayed to the recommendation receiver.

Method 400 also includes a step 406, wherein the STB of the recommendation receiver may initiate a session negotiation request message including, e.g., transmission channel information of a program stream to an SCF according to the recommendation message. Next, method 400 includes step 407, wherein the SCF sends the session negotiation request message to the MF. Then, method 400 includes step 408, whereupon after receiving the session negotiation request message, the MF sends the session negotiation response message to the SCF. Thereafter, in step 409, the SCF may send the session negotiation response message to the STB of the recommendation receiver. Note that the above describes one mechanism for establishing, negotiating and maintain session control; however, embodiments consider other well know standards or protocols for establishing session control and any specific reference to a particular type of network configuration or protocol described herein is used for illustrative purposes only and is not meant to limit or narrow the scope of the present invention unless otherwise explicitly claimed.

Regardless of the protocol used to establish a session, in step 410 of method 400, the STB of the recommendation receiver sends a play request to the MF, wherein the playing request may carry the time range instruction information and any other relevant information for identifying the program stream of the recommendation. Then, in step 411, the MF server delivers the program stream corresponding the time period to the STB of the recommendation receiver. Thereafter, in step 412 of method 400, the STB of the recommendation receiver may display the received program according to the SVG codes previously set. Then of course, method 400 includes a step 412, which sets a display mode and displays the part of the image based on the instruction information received. For example, in staying with the above outlined scenario, if the SVG=“ . . . ” means highlight within the range of the part of image, in step 412, the STB of the recommendation receiver displays the part of image in the received program in a highlight mode according to the SVG=“ . . . ”.

Similar to the above mode and range of the part of the image selection, other embodiments of the present invention provide that the recommendation message may also carry other instruction information, e.g., the time period instruction information; the SVG codes (including the range information of the part of image and the display mode information of the part of image); and/or other instructions and information used in displaying the recommendation to the receiver. Thereafter, the STB of the recommendation receiver may displays the part of image of the program stream received from the MF server according to, e.g., the SVG codes, so as to realize recommendation of important or desired images in the program stream.

### Advanced Setting of the Display Mode

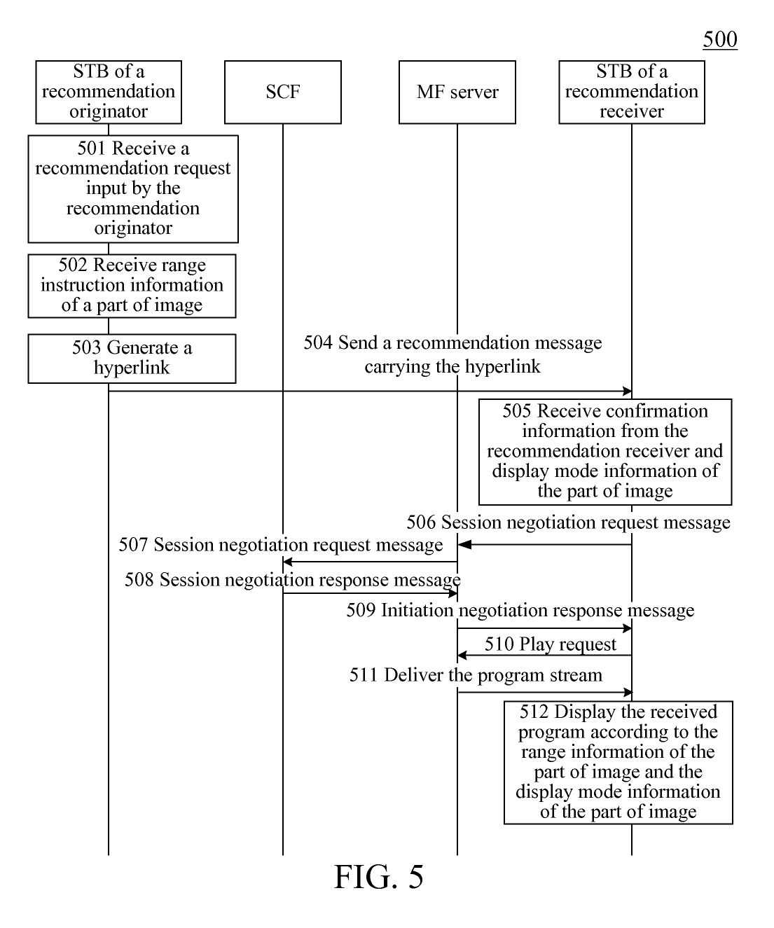

Referring again to the Figures, FIG. 5 illustrates a flow diagram of a program recommendation method 500 which allows for advanced setting of a display mode according to example embodiments of the present invention described herein. Similar to other embodiments described herein, method 500 includes step 501, wherein an STB of a recommendation originator receives a recommendation request input by a recommendation originator and provides a recommendation operation interface for the recommendation originator.

Method 500 also includes a step 502, wherein the STB of the recommendation originator receives recommendation conditions input by the recommendation originator at the operation interface and receives the recommendation receiver information. Similar to the above described embodiments, the recommendation conditions may include recommendation instruction information that selects, e.g., a part of image, range instruction information that selects, e.g., a specific part of image, and time period instruction information that selects, e.g., a time period in the media stream. Of course, as noted above, other conditions are also contemplated herein and the above list of conditions used in this and other described embodiments is used herein for illustrative purposes only unless otherwise explicitly claimed.

Regardless of the types of conditions used, method 500 also includes step 503, wherein the STB of the recommendation originator generates a recommendation media stream identifier, pointer, or instructions (e.g., hyperlink) according to, e.g., the time period instruction information, the range instruction information of the part of image, or other condition or instructions information for uniquely identifying the recommended media stream. Then, in step 504 of method 500, the STB of the recommendation originator may send a recommendation message carrying the identifier (e.g., a hyperlink) to the STB of the recommendation receiver.

Similar to other noted embodiments, Method 500 further includes a step 505, wherein the STB of the recommendation receiver determines that a part of image of the program stream needs to be specifically displayed according to the range information of the part of image in the recommendation message and prompts the recommendation receiver for input by displaying at least a portion of the recommendation message to the recommendation originator. For example, the recommendation receiver may be prompted for input by displaying the following: “Your friend Mark recommends a program to you. Do you want it or not?”. Whereupon, after receiving confirmation information to the prompt from the recommendation receiver, one example embodiment provides that the STB of the recommendation receiver may prompt the recommendation receiver to input the displaying mode information of the part of image, wherein the receiver selects the desired display mode.

Note that steps 506 to 511 are similar to steps 406 to 411; and therefore, these steps will not be described in great detail here. Instead, please refer to the related steps in FIG. 4 in reviewing the details of steps 506-511.

Method 500 also includes step 512, wherein the STB of the recommendation receiver displays the received program according to, e.g., the range information of the part of image and the displaying mode information of the part of image. In another example embodiment described herein, the recommendation receiver can also set the display mode information in the STB in advance. In such embodiment, step 505 does not prompt the recommendation receiver to input the display mode information.

For example, the recommended receiver may set the display mode in advance to: (i) allow for some a default setting; (ii) always prompt for user input; (iii) use the display mode set by the originator; or (iv) any other well know types of advanced settings. In other words, the display mode information of the part of image determined by the recommendation receiver can be: (i) the display mode information of the part of image inputted by the recommendation receiver as prompted by the STB of the recommendation receiver; (ii) the display mode information of the part of image set by the recommendation receiver in advance; or (iii) some combination thereof.

### Terminal Apparatus for Recommending a Media Stream

Referring again to the Figures, FIG. 6 illustrates a terminal and other apparatus for sending a recommended media stream according to example embodiments described herein. More specifically, the sending apparatus(es) of the present invention include(s) a message receiving unit 601, a message sending unit 602, and a program-stream receiving unit 603.

In these embodiments, the message receiving unit 601 is configured to receive a recommendation message. In one embodiment, the recommendation message may include a program ID and an ID of a part of program stream for ease in indentifying from an MF the part of a program recommended by a recommendation originator.

Likewise, the message sending unit 602 may be configured to send an instruction message for instructing an MF server to deliver the part of program stream of the program according to the program ID and the ID of the part of program stream.

Similarly, the program-stream receiving unit 603 may be configured to receive the part of program stream delivered by the MF server.

Note that a logic connection relation exists between the message sending unit 602 and the program-stream receiving unit 603. That is to say, the program-stream receiving unit 603 receives the part of program stream delivered by the MF server after the message sending unit 602 sends the instruction message.

In accordance with other embodiments described herein, the terminal device may instruct the MF server to only deliver a part of program stream according to the received ID of the part of program stream, so as to realize an objective of recommendation of a part of program stream. At the same time, as previously noted, because the MF server needs to only deliver a part of program stream, resources such as network bandwidth can be saved.

### Terminal Device for Playing a Recommended Media Stream

Referring again to the Figures, FIG. 7 shows a terminal device according to other example embodiments of the present invention, which includes: (i) a message receiving unit 701; (ii) an obtaining unit 702, a message sending unit 703; (iii) a program-stream receiving unit 704; and (iv) a playing unit 705.

In such embodiments, message receiving unit 701 is configured to receive a recommendation message. Similar to embodiments described above, the recommendation message may include, e.g., a program ID and/or range information of a part of image recommended by a recommendation originator.

Similarly, the obtaining unit 702 in FIG. 7 is configured to obtain display mode information on the part of image after receiving the recommendation message. Thereafter, the message sending unit 703 is configured to send an instruction message for instructing an MF server to deliver a program stream according to the program ID.

Likewise, the program-stream receiving unit 704 may be configured to receive the program stream delivered by the MF server.

Similarly, the playing unit 705 may be configured to play the program stream according to the range information of the part of image and the display mode information of the part of image.

Note that the obtaining unit 702 may be specifically configured to obtain the display mode information (e.g., information of a part of an image) automatically from the recommendation message. Alternatively, or in conjunction, the obtaining unit 702 may be specifically configured to receive the display mode information (e.g., of the part of image) determined by the recommendation receiver through manual input by the receiver and a user interface displayed as noted above.

Similar to the configuration noted above, a logic connection relation exists between the message sending unit 703 and the program-stream receiving unit 704. That is to say, the program-stream receiving unit 704 receives the program stream delivered by the MF server after the message sending unit 703 sends the instruction message.

Example embodiments also provide that the terminal device can play the program stream received from the MF server according to the range information of the part of image and the display mode information (e.g., of the part of image), so as to realize an objective of recommendation of important images in the program stream.

### System Used to Provide Recommended Media Stream

Referring again to the Figures, FIG. 8 shows a network system according to example embodiments of the present invention described herein. As shown, the system includes: (i) a terminal of a recommendation originator 801; and (ii) a terminal of a recommendation receiver 802.

Note that the terminal of the recommendation originator 801 may be configured to: (i) receive a recommendation condition including, e.g., recommendation instruction information of a part of program stream; (ii) generate a recommendation message according to the recommendation condition; and (iii) send the recommendation message to the terminal of the recommendation receiver 802. Note that the recommendation message will generally include a program ID and an ID of the part of program stream recommended by the recommendation originator. For example, the recommendation message may include a hyperlink similar in form as the hyperlinks previously described above.

Similar to embodiments described above, the terminal of the recommendation receiver 802 may be configured to receive the recommendation message sent by the terminal of the recommendation originator 801, send an instruction message for instructing an MF server to deliver the part of program stream of the program according to the program ID and the ID of the part of program stream, and receive the part of program stream delivered by the MF server. Note that in one embodiment, the terminal device(s) of the recommendation originator and/or recommendation receiver can be an STB.

Assuming the terminal devices are STBs, other embodiments of the present invention provide that the STB of the recommendation originator sends the ID of the part of program stream to the STB of the recommendation receiver. The STB of the recommendation receiver may then instruct the MF server to deliver only the part of program stream through the ID of the part of program stream, so as to realize an objective of recommendation of the part of program stream. At the same time, as the MF server needs to deliver only the part of program stream, resource such as network bandwidth can be saved.

### System Communication Between Originating and Receiving Terminals

A network system according to other example embodiments described herein includes: (i) a terminal of a recommendation originator; and (ii) a terminal of a recommendation receiver. A schematic view of connection between the terminal of the recommendation originator and the terminal of the recommendation receiver is the same as in FIG. 8.

As shown in FIG. 8, the terminal of the recommendation originator may be configured to: (i) receive a recommendation condition including, e.g., range instruction information of a part of image; (ii) generate a recommendation message according to the recommendation condition; and (iii) send the recommendation message to the terminal of the recommendation receiver. Note that the recommendation message may includes a program ID and/or range information (e.g., for part of an image) recommended by the recommendation originator.

Also shown in FIG. 8, the terminal of the recommendation receiver may be configured to: (i) receive the recommendation message sent by the terminal of the recommendation originator; (ii) obtain display mode information of the part of image; (iii) send an instruction message for instructing an MF server to deliver a program stream according to the program ID; (iii) receive the program stream delivered by the MF server; and (iv) play the program stream according to the range information of the part of image and the display mode information of the part of image.

Similar to above, the terminal of the recommendation originator and/or recommendation receiver can be an STB. In such instance, example embodiments of the present invention provide that the terminal of the recommendation receiver may play the program stream received from the MF server according to the range information of the part of image and the display mode information of the part of image, so as to realize an objective of recommendation of important images in the program stream.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A program recommendation method, comprising:
receiving, by a terminal of a recommendation receiver, a recommendation message sent by a terminal of a recommendation originator, wherein the recommendation message includes a program identity (ID), an ID of a part of program stream recommended by the recommendation originator, or both;
sending an instruction message for instructing a media function (MF) server to deliver the part of program stream of the program according to the program ID, the ID of the part of program stream, or both; and
receiving the part of program stream delivered by the MF server.

2. The method according to claim 1, further comprising:
receiving, by the terminal of the recommendation originator, a recommendation condition comprising recommendation instruction information of the part of program stream, and generating the recommendation message according to the recommendation condition.

3. A program recommendation method, comprising:
receiving, by a terminal of a recommendation receiver, a recommendation message sent by a terminal of a recommendation originator, wherein the recommendation message comprises a program identity (ID) and range information of a part of image recommended by the recommendation originator;
obtaining display mode information of the part of image;
sending an instruction message for instructing a media function (MF) server to deliver a program stream according to the program ID; and
receiving the program stream delivered by the MF server, and playing the program stream according to the range information of the part of image and the display mode information of the part of image.

4. The method according to claim 3, wherein
the recommendation message further comprises the display mode information of the part of image; and
the obtaining the display mode information of the part of image is specifically:
obtaining the display mode information of the part of image from the recommendation message.

5. The method according to claim 3, wherein the obtaining the display mode information of the part of image is specifically:
receiving, by the terminal of the recommendation receiver, the display mode information of the part of image determined by the recommendation receiver.

6. The method according to claim 3, further comprising:
receiving, by the terminal of the recommendation originator, a recommendation condition comprising range instruction information of the part of image, and generating the recommendation message according to the recommendation condition.

7. The method according to claim 4, further comprising:
receiving, by the terminal of the recommendation originator, a recommendation condition comprising range instruction information of the part of image, and generating the recommendation message according to the recommendation condition.

8. The method according to claim 5, further comprising:
receiving, by the terminal of the recommendation originator, a recommendation condition comprising range instruction information of the part of image, and generating the recommendation message according to the recommendation condition.

9. A terminal device, comprising:
a message receiving unit, configured to receive a recommendation message comprising a program identity (ID) and an ID of a part of program stream recommended by a recommendation originator;
a message sending unit, configured to send an instruction message for instructing a media function (MF) server to deliver the part of program stream of the program according to the program ID and the ID of the part of program stream; and
a program-stream receiving unit, configured to receive the part of program stream delivered by the MF server.

10. A terminal device, comprising:
a message receiving unit, configured to receive a recommendation message comprising a program identity (ID) and range information of a part of image recommended by a recommendation originator;
an obtaining unit, configured to obtain display mode information of the part of image after receiving the recommendation message;
a message sending unit, configured to send an instruction message for instructing a media function (MF) server to deliver a program stream according to the program ID;
a program-stream receiving unit, configured to receive the program stream delivered by the MF server;
a playing unit, configured to play the program stream according to the range information of the part of image and the display mode information of the part of image.

11. The terminal device according to claim 10, wherein
the obtaining unit is configured to obtain the display mode information of the part of image from the recommendation message.

12. The terminal device according to claim 10, wherein
the obtaining unit is configured to receive the display mode information of the part of image determined by a recommendation receiver.

13. A network system, comprising: a terminal of a recommendation originator and a terminal of a recommendation receiver, wherein
the terminal of the recommendation originator is configured to receive a recommendation condition comprising recommendation instruction information of a part of program stream, and send a recommendation message comprising an program identity (ID) and an ID of the part of program stream recommended by the recommendation originator to the terminal of the recommendation receiver according to the recommendation condition, and
the terminal of the recommendation receiver is configured to receive the recommendation message sent by the terminal of the recommendation originator, send an instruction message for instructing a media function (MF) server to deliver the part of program stream of the program according to the program ID and the ID of the part of program stream, and receive the part of program stream delivered by the MF server.

14. A network system, comprising: a terminal of a recommendation originator and a terminal of a recommendation receiver, wherein
the terminal of the recommendation originator is configured to receive a recommendation condition comprising range instruction information of a part of image, and send a recommendation message comprising a program identity (ID) and range information of the part of image recommended by the recommendation originator to the terminal of the recommendation receiver according to the recommendation condition, and
the terminal of the recommendation receiver is configured to receive the recommendation message sent by the terminal of the recommendation originator, obtain display mode information of the part of image, send an instruction message for instructing a media function (MF) server to deliver a program stream according to the program ID, receive the program stream delivered by the MF server, and play the program stream according to the range information of the part of image and the display mode information of the part of image.
